(19) United States
(12) Patent Application Publication
(10) Pub. No.: US 2023/0046646 A1
(43) Pub. Date: Feb. 16, 2023

(54) GAMIFIED PARTICIPATORY RECOMMENDER SYSTEM

(71) Applicants: Matthew R. Artz, Dresher, PA (US); Geoffrey C. Speicher, Archbald, PA (US)

(72) Inventors: Matthew R. Artz, Dresher, PA (US); Geoffrey C. Speicher, Archbald, PA (US)

(21) Appl. No.: 17/401,166

(22) Filed: Aug. 12, 2021

(51) Int. Cl. G06Q 30/02; G06Q 50/00

(52) U.S. Cl. CPC G06Q 30/0272; G06Q 50/01; G06Q 30/0277

(57) ABSTRACT

A Gamified Participatory Recommender System is disclosed which employs Content-based Art Recommendations which are combined with Collaborative Filtering Art Recommendations and are adjusted by the Participation Score of the Current User to identify Art similar to art that a Current User is viewing. The similar Art is displayed to the Current User, and the Current User's actions are monitored. Subsequent recommendations are adjusted based upon the Current User's actions. The System also employs Content-based User Recommendations which are combined with Collaborative Filtering User Recommendations that are adjusted by a Participation Score of the Current User to identify similar Users and create links between the Current User and at least one similar User. These recommendations are affected by the amount of user participation, thereby rewarding those with extensive user participation.

### CROSS-REFERENCE TO RELATED APPLICATIONS

Not Applicable.

### STATEMENT REGARDING FEDERALLY SPONSORED RESEARCH

Not Applicable.

### BACKGROUND

### 1. Field of Invention

The present invention relates to a Gamified Participatory Recommender System, which employs gamified user feedback to allow users in a multi-sided market such as fine art, to participate in and influence how often their art and user profiles are recommended by the system, based on users' behaviors while using the system.

### 2. Description of Related Art

Conventional cultural markets for fine art, typically involved creators of artistic works (“Artists”), artist gallery representatives (“Gallery Reps”), and buyers (“Collectors”). The Artists, Gallery Reps and Buyers may be collectively referred to as “Art Entities”.

Some of the Entities have significantly more monetary wealth referred to as “economic capital”. Some of the Art Entities have significant social capital, or significant access to social networks. Some of the Art Entities have cultural capital, which is knowledge, skills, and credentials.

Art Entities with more economic, social and/or cultural capital can use their capital to increase their access, mobility, and popularity within cultural markets. Likewise, these Art Entities tend to receive more exposure, operate at higher strata within the market topography, and be more successful in conventional art markets, leading to a ‘rich-get-richer’ scenario.

Conversely Art Entities with less capital are often less popular and thus have a harder time breaking into and exceling within the established art market. Said Entities often find themselves regulated to lower strata of the art market where they exert less influence on the art market and often have a difficult time transacting at business a value commensurate with Entities at higher strata.

Digital on-line trading and sales systems for art, music and other cultural items having multiple types of users can be referred to as multi-sided cultural market systems. These have similar problems as traditional cultural markets mentioned above. This applies to fine art, as much as it does to other key cultural markets such as music, books, entertainment, fashion, collectibles, and luxury goods. In such markets, the success of the Entities and their products is still predicated on their access, mobility, and popularity within the market, which is ultimately tied their economic, social, and cultural capital.

However, the problems described above are also amplified by the inherent limitations and bias that is built into the design of existing art trading and sales systems referred to as recommendations systems, also known as recommendation engines.

### Recommender Systems & Popularity Bias

Online recommender systems are arguably the most common tools used to support users in finding relevant information such as products, brands, people, music, or art in digital markets. Such systems are described in Ricci, F., Rokach, L., Shapira, B., “Introduction to recommender systems handbook,” In: Ricci, F., Rokach, L., Shapira, B., Kantor, P.B. (eds.) Recommender Systems Handbook, pp. 1-35. Springer, Boston (2011). https://doi.org/10.1007/978-0-387-85820-3.1

These recommender systems typically make use of metrics such as user views, user ratings, or similarities between pieces of art to calculate suggestions. Yet, recommender systems, are known to suffer from popularity bias and result in unfair recommendations that favor some entities with more capital over others. This results in markets offer fewer opportunities for discovery, innovation, and creativity.

As described above, Art Entities with larger amounts of capital are easier to find in on-line systems (digital markets) when compared to lesser-known Entities with less capital. The easier it is for potential buyers to find an Art Entity the greater the chance that the Art Entity can make a sale. The more sales an Art Entity makes, the more capital it accumulates and the more it is recommended. This vicious cycle creates an unequal “winner-takes all” scenario that makes it increasingly difficult for the Art Entity with little capital to break-in and succeed as an unknown Entity with little capital.

Currently, there is a need for an equitable recommender system that can overcome common problems with existing recommender systems and the problems in digital cultural markets encountered by Art Entities lacking access to economic, social, and cultural capital.

### SUMMARY OF THE INVENTION

Throughout the description of this invention, measurements, user inputs and monitored actions may be converted into data. The data may be manipulated to result in intermediate data or results which may be referred to as values or scores. These values or scores may be converted into equivalent electronic signals and passed from one element to another where it may be converted back into data and manipulated further. It is therefore to be understood that values, data, scores and signal can be equivalent.

The invention may be described as a system for iteratively providing Art to a Current User to view and linking the Current User to a similar Recommended User. It employs a Behavior Events Monitor in a User Device that monitors behavior of the Current User and sends the user behavior to a Controller in a Cloud Server that stores them in a Behavior Storage in the Cloud Server. It includes a Participation Calculator that reads the user behavior from the Behavior Storage and uses it to create a Participation Signal. An Art Match Predictor receives previously stored user actions from the Behavior Storage and previously stored user preferences from a User Preference Device and previously stored Art and Art Attributes from an Art Attribute Storage and employs these to determine similar art liked by the Current User and creates an Art Match Predictor signal indicating the determined similar Art.

An Art Recommendation Device receives the Participation Signal from the Participation Calculator and also receives the Art Match Predictor signals from the Art Match Predictor and determines a piece of Recommended Art to display to the Current User.

A User Match Predictor determines a similar user to the Current User and creates a User Match Prediction Signal indicating the determined similar user;

A User Recommendation Device is coupled to the Participation Calculator that receives a Participation Signal from the Participation Score Calculator and receives the User Match Prediction Signal from the User Match Predictor and determines a user which is most similar to the Current User.

A Controller receives an indication of the Recommended Art to display to the Current User from the Art Recommendation Device and extracts the Recommended Art from the Art Attribute Storage and provides it to the User Device, wherein the User Device displays the Recommended Art on an Input/Output Device to the Current User.

The Controller also receives an indication of the Recommended User from the User Recommendation Device, creates a link to the Recommended User and provides this link to the Current User allowing the Current User to connect with, and message the Recommended User.

The current invention may also be embodied as a method for incorporating a measure of user participation of a Current User into a Participatory Recommender System to produce recommendations, having the steps of collecting Engagement Attributes, Cooperation Attributes and Action Attributes which indicate preferences and behavior information of the Current User;

calculating a Content-based Art Recommendation Component and a Collaborative Filtering Art Recommendation Component at least partially from Engagement Attributes, Cooperation Attributes and Action Attributes of the Current User;

combining the Content-based Art Recommendation Component with the Collaborative Filtering Art Recommendation Component to create an Art Match Predictor Signal;

calculating a Participation Signal from the Engagement, Cooperation and Action Attributes;

combining the Participation Signal with the Art Match Predictor to create an Art Recommendation Signal indicating Recommended Art;

acquiring Recommended Art indicated by the Art Recommendation Signal;

displaying the Recommended Art to the Current User; and

collecting feedback of the Current User's preferences and behavior that is then iteratively fed back into the Participatory Recommender System and used in the above calculations.

The current invention may also be embodied as a method of producing an Art Recommendation by incorporating a measure of user participation into a Participatory Recommender System, by executing the steps of determining an Engagement Score (ES) from previously measured Engagement Attributes;

determining a Cooperation Score (CS) from previously measured Cooperation Attributes;

determining an Action Score (AS) from previously measured Action Attributes;

combining the Engagement Score (ES), Cooperation Score (CS) and the Action Score (AS) into a Participation Signal;

creating a Content-based Art Recommendation Component;

creating a Collaborative Filtering Art Recommendation Component;

combining the Content-based Art Recommendation Component and the Collaborative Filtering Art Recommendation Component to result in an Art Match Predictor for the Current User;

combining the Art Match Predictor with the Participation Score into an Art Recommendation. It also involves displaying to the Current User, Art pertaining to the Art Recommendation;

monitoring the Current User's actions regarding the Art displayed to update at least one of the Engagement Score (ES), Cooperation Score (CS) and the Action Score (AS) stored in the Behavior Storage.

Additionally, an embodiment of the current invention may employ the following steps of creating a Content-based User Recommendation Component;

creating a Collaborative Filtering User Recommendation Component;

combining the Content-based User Recommendation Component and the Collaborative Filtering User Recommendation Component to result in a User Match Prediction for the Current User;

combining the User Match Prediction with the Participation Signal to create a User Match Recommendation recommending the Recommended User to the Current User;

providing to the Current User a link to the Recommended User; and

monitoring the Current User's actions regarding the link provided to update the Engagement Score (ES), Cooperation Score (CS), and the Action Score (AS) in the Behavior Storage.

The invention may be embodied as the method above wherein an Engagement Calculator calculates an Engagement Score (ES) from a plurality of Engagement Attributes normalized to a range between 0 and 1 that are then weighted according to importance. The Engagement Attributes include at least one of: a number of sessions, an average session duration, a number of continuous use days of a specified length, a number of pieces of art shared, and a number of user profiles shared.

The invention may be embodied as the method above wherein the Cooperation Calculator calculates a Cooperation Score (CS) from a plurality of Cooperation Attributes normalized to a range between 0 and 1 that are then weighted according to importance. The Cooperation Attributes include at least one of: a number of connection requests, a number of connections accepted, an average number of messages sent, and an average message response time.

The invention may be embodied as the method above wherein the Action Calculator calculates an Action Score (AS) from a plurality of Action Attributes normalized to a range between 0 and 1 that are then weighted according to importance. The Action Attributes include at least one of: a number of times a profile of User 1 is reported by another user; a number of times artwork of Current User 1 is reported by another user; a number of times a message of User lis reported by another user; a number of times User 1was blocked by another user; and a number of times User 1 was removed from user matches by another user.

### BRIEF DESCRIPTION OF THE DRAWINGS

The advantages of the system described in this application will become more apparent when read with the exemplary embodiments described in the specification and shown in the drawings. Further, in the accompanying drawings and description that follow, like parts are indicated throughout the drawings and description with the same reference numerals, respectively. The figures may not be drawn to scale and the proportions of certain parts have been exaggerated for convenience of illustration.

FIG. 1A is a simplified block diagram of one embodiment of a system according to the current invention illustrating the ‘setup phase’ for Artists, and Gallery Reps.

FIG. 1B is a simplified block diagram of one embodiment of a system according to the current invention illustrating the ‘setup phase’ for potential buyers (or “Collectors”).

FIG. 2 is a simplified block diagram of one embodiment of a system according to the current invention illustrating data collection and storage.

FIG. 3 is a simplified block diagram of one embodiment of a system according to the current invention illustrating the ‘art recommendation process’ of the ‘operating phase’ for the for Artists and Gallery Reps.

FIG. 4 is a simplified block diagram of one embodiment of a system according to the current invention illustrating the ‘user recommendation process’ of the ‘operating phase’.

FIG. 5 is a more detailed block diagram of the Participation Calculator of FIGS. 1A-4.

FIG. 6A is an illustration of the functioning of a Content-based Recommendation Model which is used with the current invention for recommending art.

FIG. 6B is an illustration of the functioning of a Collaborative Filtering Recommendation Model which is used with the current invention for recommending art.

FIG. 6C is a more detailed illustration of the Art Match Predictor being used for recommending art shown in FIGS. 1A-4.

FIG. 7A is an illustration of the functioning of a Content-based Recommendation Model which is used with the current invention for recommending a user to the Current User.

FIG. 7B is an illustration of the functioning of a Collaborative Filtering Recommendation Model which is used with the current invention for recommending a user to the Current User.

FIG. 7C is a more detailed illustration of the Match Prediction Device being used for recommending Users shown in FIGS. 1A-4.

FIG. 8 is a more detailed block diagram of the Art Recommendation Device of FIGS. 1A-4.

FIG. 9 is a more detailed block diagram of the User Recommendation Device 2600 of FIGS. 1A-4.

FIG. 10 is an illustration of a display of a User Device showing a user interface that provides feedback to users on how their Participation Score is modifying their overall influence within the Participatory Recommender System.

FIG. 11 is flowchart illustrating how user participation is merged into the Gamified Participatory Recommender System according to one embodiment of the current invention.

FIG. 12 is flowchart illustrating the Art Match Recommendation function of the Gamified Participatory Recommender System according to one embodiment of the current invention.

FIG. 13 is flowchart illustrating the user match recommendation function of the Gamified Participatory Recommender System according to one embodiment of the current invention.

FIG. 14 is flowchart illustrating the gamified aspects of the Gamified Participatory Recommender System according to one embodiment of the current invention.

FIG. 15 is a table displaying examples of attributes, time period, base value, target value, and weighting that are used to calculate the Engagement Score (ES).

FIG. 16 is a table displaying examples of attributes, time period, base value, target value, and weighting that are used to calculate the Cooperation Score (CS).

FIG. 17 is a table displaying examples of attributes, time period, base value, target value, and weighting that are used to calculate the Action Score (AS).

### DETAILED DESCRIPTION

The present invention will now be described in detail by describing various illustrative, non-limiting embodiments thereof with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

1. Theory

The current system deals with digital multi-sided cultural markets for fine art, with the three sides involving creators of artistic works (“Artists”), artist gallery representatives (“Gallery Reps”), and buyers (“Collectors”).

Prior art recommender systems are skewed toward giving preference to users having large amounts of capital (economic, social and cultural). This leads to a ‘winner takes all’ result with Art Entities having little capital getting little or no exposure.

The current system leverages a new form of capital (behavior capital) which is based upon the Entity's continued productive participation in the system. Productive participation is defined by the developer of the system as behavior that produces value for the user community.

The current invention blends this concept of behavior capital with existing techniques for recommender systems such as content-based and collaborative filtering models, or a hybrid thereof.

### Content-Based Models

Content-based models use item features such as the style of a piece of art of the genre of music to recommend other items similar to those the users has indicated he/she likes. This is based on previous actions or input of the users. While content-based models are useful since information about other users is not needed, they are limited in their ability to introduce new content to a given user since the recommendations are based on past actions of the user.

### Collaborative Filtering Models

Collaborative Filtering Models try to address the shortcomings of Content-based Models by using the similarities between users and content to make recommendations. This allows the system to make recommendations to a user that differs from their past actions. While this approach provides some benefit, it cannot factor in new content or users into the model.

The net effects are systems which exhibit issues with bias and fairness with respect to capital:
a. Biased inputs result in a ‘rich-get-richer’ or ‘winner-takes-all’ scenario since users or content with positive feedback in a machine learning model are likely to keep collecting additional feedback given the nature of machine learning algorithms.
b. Content or users are not recommended based on merit, and instead based on biased inputs, resulting in unequal exposure.

These problems and others are described in “Popularity Bias in Ranking and Recommendation” In AAAI/ACM Conference on AI, Ethics, and Society (AIES'19) Jan. 27-28, 2019, Honolulu, Hi., USA. ACM and in Erik Brynjolfsson, Yu Jeffrey Hu, and Michael D Smith. 2006, and “From niches to riches: Anatomy of the long tail”, Sloan Management Review 47, 4 (2006), 67-71.

The above problems causing the ‘winner takes all’ scenario is inherent in on-line markets and recommender systems which, by their nature, cause the technical problems of certain users being over-represented while many other users are significantly under-represented. Since this inequity is inherent in these types of systems, it may be considered a technical problem.

The current invention provides a technical solution to this technical problem. It weighs in a third kind of capital based upon the user's participation, to offset the recommendations of the system to decrease the representation of those with a large amount of monetary and social capital; and increase the representation of those with little monetary and social capital.

To address the shortcomings of prior art recommender systems which are skewed in favor of those with more economic, social, and cultural capital, the current system incorporates a novel concept of behavior capital into a recommender system for this invention. Like other forms of capital which confers value or benefit to its owner, behavior capital rewards users for their actions within the system, regardless of a user's offline economic, social, or cultural capital. In this model, desired behaviors such as engagement, cooperation and action will be rewarded, and encouraged through a gamification model that provides feedback to the users on their individual performance and performance compared to the community. This feedback will be used to allow users to compete and improve their Participation Scores. This will in turn increase their overall influence in the Gamified Participator Recommender System and increase the likelihood that their profile and/or artwork will be recommended. This levels the playing field for Art Entities having little monetary and social capital.

2. Implementation

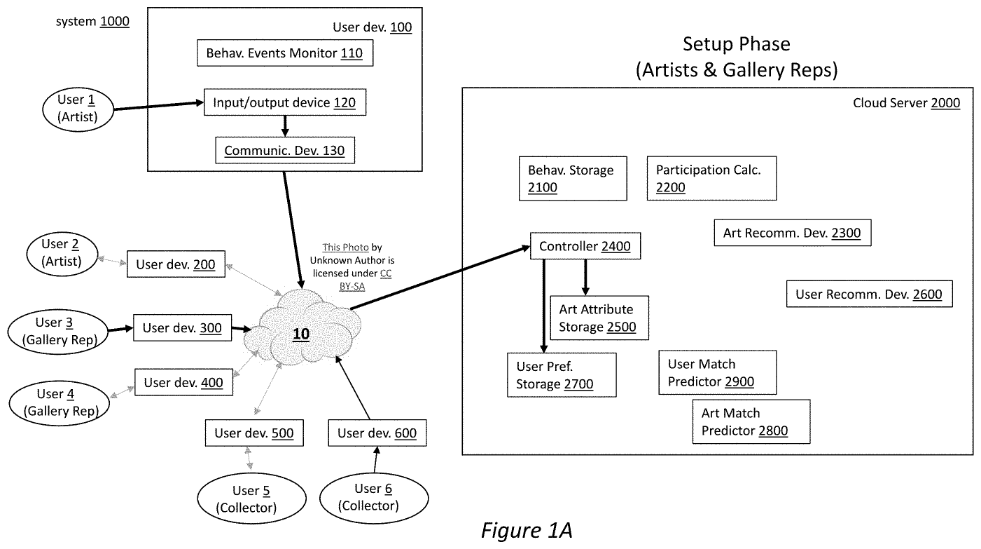

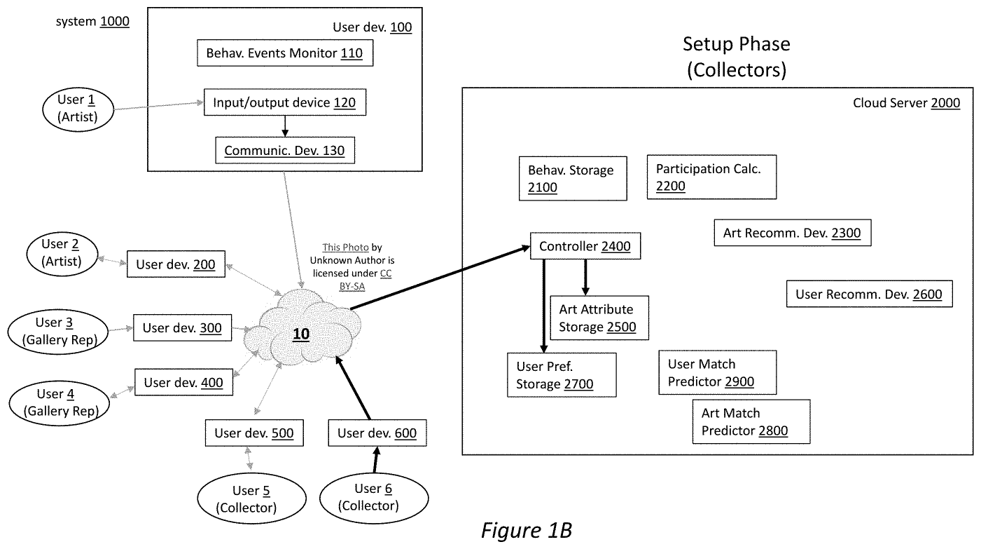

### FIG. 1A

Throughout this application, elements of the Gamified Participatory Recommender System 1000 may perform one or more of the functions of receiving input signals, monitoring physical phenomena to create signals, converting signals to data, storing the data, manipulating the data, converting data to electronic signals for transmission to other elements, and transmitting signals to other elements. The data may be referred to as “values”, “scores”, and “results”, and can all be converted to and from electronic signals. Therefore, throughout this application, the above should be considered equivalent since they can be easily converted.

FIG. 1A shows a system 1000 according to one embodiment of the present invention. This system 1000 provides a conduit in which Artists, Gallery Reps, and Collectors can interact to display, discuss, and share art. It is also a place where Artists, Gallery Reps and Collectors can build relationships. The system 1000 is designed to facilitate these functions.

User 1 and user 2 are Artists who are connecting to a Cloud Server 2000 through User Devices 100 and 200, respectively and network 10. Users 3 and 4 are Gallery Reps and are also connecting to the Cloud Server 2000 through User Devices User Devices 300 and 400, respectively. Users 5 and 6 are Collectors that are also connecting to the Cloud Server 2000 through User Devices 500 and 600, respectively then through network 10.

Network 10 can be any combination of cellular, wireless, Bluetooth, or hardwired networks which may include local networks, wide area networks and/or the Internet.

For the purpose of illustration, we will discuss User 1, providing initial information to the system during a setup phase.

Initially, Controller 2400 requests information from User 1 to create an account. Later, Controller 2400 quizzes and receives user preferences during an onboarding process and stores the information in a User Preference Storage 2700 which may be any type of device which is capable of storing and retrieving digital information.

Controller 2400 requests that User 1 identifies if he/she is an Artist, a Gallery Rep, or a Collector. In the case of User 1, Artist will be selected. Information that the Gamified Participatory Recommender System 1000 also may request from the Current User may be:
a profile photo,
the user's name,
an app handle (username),
the user's gender,
the user's date of birth,
a web address,
profile description,
the user's address (city, state, zip),
art price range,
social media links and/handles for the user's social media accounts, and
similar information.

During the onboarding process, the Gamified Participatory Recommender System 1000 will then ask the Current User to select categories and styles of art that the Current User either creates or represents and services that they either need or offer.

Such categories may include, but are not limited to:
portraiture,
figure,
religious,
historical,
landscape,
still life,
objects,
conceptual,
abstraction, and
landscapes.

This information that was provided by the Current User is then stored.

Styles may include but are not limited to:
realism,
art nouveau,
impressionism,
post-impressionism,
pointillism,
fauvism,
expressionism,
cubism,
surrealism,
abstract expressionism,
op art,
pop art,
arte povera,
minimalism,
conceptual art,
contemporary art,
neo-expressionism,
street art,
African diaspora,
Latin American,
Caribbean,
Futurism,
folk art,
ukiyo-e,
outsider art,
primitivism,
naive art,
social realism,
pictures generation,
postmodern,
transavanguardia,
new media art,
post-internet, and
relational practices.

Services provided by the Art Entity may include, but are not limited to:
exhibitions,
consulting and selection,
framing,
research,
provenance,
placement and installation,
conservation and restoration,
packing and shipping,
brokering and resale,
appraisal and evaluation,
auctions,
donations,
inventory,
gallery rental,
social media marketing,
legal advice, and
legacy planning.

User 1 may choose to upload art through Controller 2400 to be stored in Art Attribute Storage 2500 which may be any type of device which is capable of storing and retrieving digital information. User 1 is also requested to provide attributes of the art being uploaded which is stored with the art. These art attributes may include:
title,
artist name (inferred in this case since User 1 is created an artist account during onboarding),
art medium,
art width (inches),
art length (inches)
price ($ USD),
year created,
description,
tags,
categories,
styles, and
additional media (images or videos).

The information provided by User 1 relating to art attributes is stored in the Art Attribute Storage 2500. (This may be repeated for as many pieces of art that User 1 chooses to upload.)

As will be described later, the system is monitoring and storing user behavior, if any. This may be the user swiping art displayed on his/her User Device. For example, swiping the image on a touch sensitive screen to the left means that User 1 does not like the art and swiping to the right show that the User 1 likes the art. Until the User begins swiping or interacting with other users, there is no behavior to store.

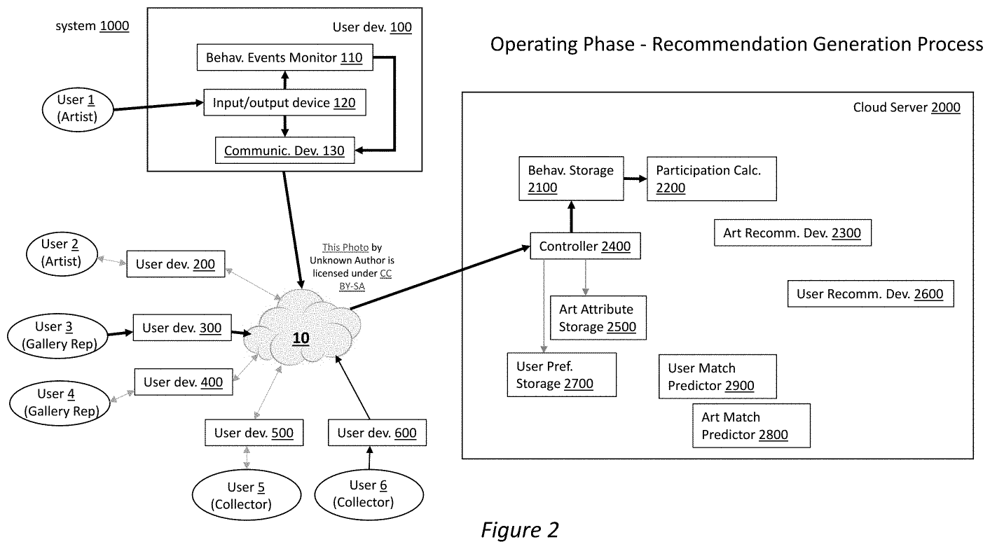

The input from User 1 relating to user preferences is stored in User Preference Storage 2700. Later, behavior of the user is monitored and is stored in Behavior Storage 2100, as shown in FIG. 2.

The process shown and described with respect to FIG. 1A applies to users who are Artists and Gallery Reps. This onboarding process is repeated for other Artists and Gallery Reps as they contact the system 1000. All users are able to edit the preferences on their profile at any time.

After there has been sufficient onboarding and art input from a user, the user is provided with art images and interacts with them. Since there are multiple users using the system continuously, this is being described sequentially for a given user, throughout this application. It is to be understood that the onboarding process will overlap operational process of other users, but generally, users upload at least some information prior to entering their operational process. FIG. 1B

Users 5 and 6 who are Collectors have a similar, but slightly different onboarding process. User Devices 500, 600 are provided with questions similar to those provided to the User Devices of the Artists and Gallery Reps, except for the upload of art and questions relating to the uploaded art.

Controller 2400 requests information from User 6 to create an account. Later, Controller 2400 quizzes and receives user preferences during an onboarding process and stores the information in a User Preference Storage 2700.

Controller 2400 requests that user 6 identifies if he/she is an Artist, a Gallery Rep., or a Collector. In the case of User 6, Collector will be selected. Controller 2400 also may request:
a profile photo,
the user's name,
an app handle (username),
the user's gender,
the user's date of birth,
a web address,
profile description,
the user's address (city, state, zip),
art price range,
social media links and/handles for the user's social media accounts, and
similar information.

During the onboarding process, the system 1000 will then ask the user to select categories styles of art that the User 6 is interested in, and services that the User 6 may need.

Such categories may include, but are not limited to:
portraiture,
figure,
religious,
historical,
landscape,
still life,
objects,
conceptual,
abstraction, and
landscapes.

Styles may include but are not limited to:
realism,
art nouveau,
impressionism,
post-impressionism,
pointillism,
fauvism,
expressionism,
cubism,
surrealism,
abstract expressionism,
op art,
pop art,
arte povera,
minimalism,
conceptual art,
contemporary art,
neo-expressionism,
street art,
African diaspora,
Latin American,
Caribbean,
Futurism,
folk art,
ukiyo-e,
outsider art,
primitivism,
naive art,
social realism,
pictures generation,
postmodern,
transavanguardia,
new media art,
post-internet, and
relational practices.

Services may include, but are not limited to:
consulting and selection,
framing,
research,
provenance,
placement and installation,
conservation and restoration,
packing and shipping,
brokering and resale,
appraisal and evaluation,
auctions,
donations,
legal advice, and
legacy planning.

The process shown in described with respect to FIG. 1B applies to users who are Collectors. This onboarding process is repeated for other Collectors as they contact the system 1000. All users are able to edit the preferences on their profile at any time.

After there has been sufficient onboarding, the system begins its operational mode in FIG. 2.

### FIG. 2

FIG. 2 is a simplified block diagram of one embodiment of a System according to the current invention. This shows the beginning of the Operating Phase for Artists and Gallery Reps.

In this phase, Controller 2400 takes art from Art Attribute Storage 2500 and provides the art selectively to User Devices 100, 200, 300, 400, 500, and 600. Each user has an Input/Output (I/O) Device such as device 120 that displays the art to the selected user. I/O Devices may be computing devices which have the capability to receive and display images and to communicate with other remote computing devices. These may be smartphones, laptops, desktop computers, or similar digital processing equipment. The I/O Device may be any known device which receives input from a user and provides output to the user. This may include a touch screen, touchpad, keyboard, monitor, display device, or other device which allows one to swipe images or simulate swiping images.

The Users are instructed to swipe the image on the I/O Device right if they like the image and swipe left if they do not. As each image is swiped to the right or left, another image replaces it. Over the course of time, the users swiping right or left gives an explicit indication of the user's art interests, which is compared to the art preferences they specified during onboarding.

Each User Device similar to User Device 100 includes a Behavior Monitor 110. This Behavior Monitor 110 keeps track of information such as user actions and other events. Said information is stored in the Behavior Storage2100.

Each User Device also has a communication device such as 130 of User Device 100. This Communication Device 130 allows each user to connect with other users to request connections and communicate through chat functionality.

Information from the Behavior Monitor 110 is also sent through Communication Device 130 through the network 10 to Controller 2400 which is stored in Behavior Storage2100.

To illustrate the operation of system 1000, User 1, who is an Artist, provides information to an Input/Output Device 120 of User Device 100. All activity of User Device 100 is monitored by a Behavior Events Monitor 110. The information from User 1 is sent to a Communication Device 130 of User Device 100, which transmits it through the cloud 10 to a Controller 2400 of the Cloud Server 2000.

Similarly, user 3, which happens to be a Gallery Rep, interacts through User Device 300 and cloud 10 to connect with Controller 2400 of Cloud Server 2000.

(A similar process is performed for users that are Collectors.)

The Behavior Events Monitor 110 of each User Device 100 monitors all input and output of Input/Output Device 120 and the type of input or output, such as communications between users, recommendations of art or users, image display, etc. This information is then provided to Controller 2400 through Communications Device 130 and is stored in the Behavior Storage 2100. Similarly, Controller 2400 also stores monitored actions of User 3 in Behavior Storage 2100.

The information of each User Device monitored includes Engagement Attributes such as:
the number of sessions,
the average session duration,
the average #of swipes per session,
the number of 10-day streaks of use,
sharing art out to social media, and
sharing user profiles out to social media.

The Engagement Attributes above are combined into an ‘Engagement Score (ES)’.

The information of each User Device monitored includes Cooperation Attributes such as:
connection requests initiated,
connection requests accepted,
average number of messages sent per thread, and
average message response time.

The Cooperation Attributes above is combined into a ‘Cooperation Score (CS)’.

Action Attributes include:
reporting of user profiles
reporting of user artwork
reporting of user messages
blocking of users, and
removal of user matches.

The Action Attributes above are combined into an ‘Action Score’ (AS).

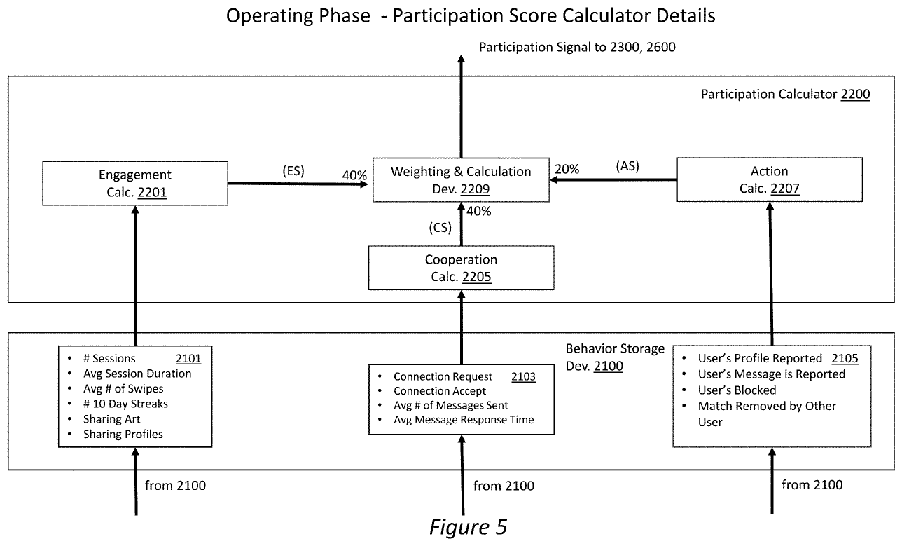

The behavior of the users is constantly being monitored and stored in Behavior Storage 2100. A Participation Calculator 2200 calculates a Participation Score for each user. (This device is described in greater detail in connection with FIG. 5 later.) The Participation Scores for each user are constantly being updated by the system as more behavior information is accumulated. These Participation Scores are sent as an encoded signal to an Art Recommendation Device 2300 and a User Recommendation Device 2600. This is only half of the picture, though.

The art attributes for each piece of art which were previously stored in the Art Attributes Storage 2500 as described in FIG. 1A, are provided to the Art Match Predictor 2800.

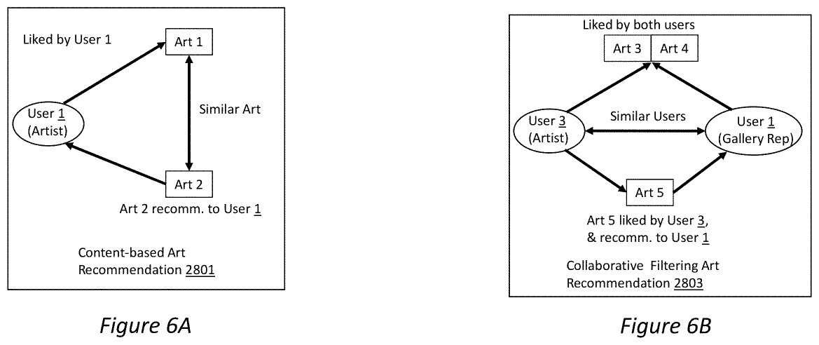

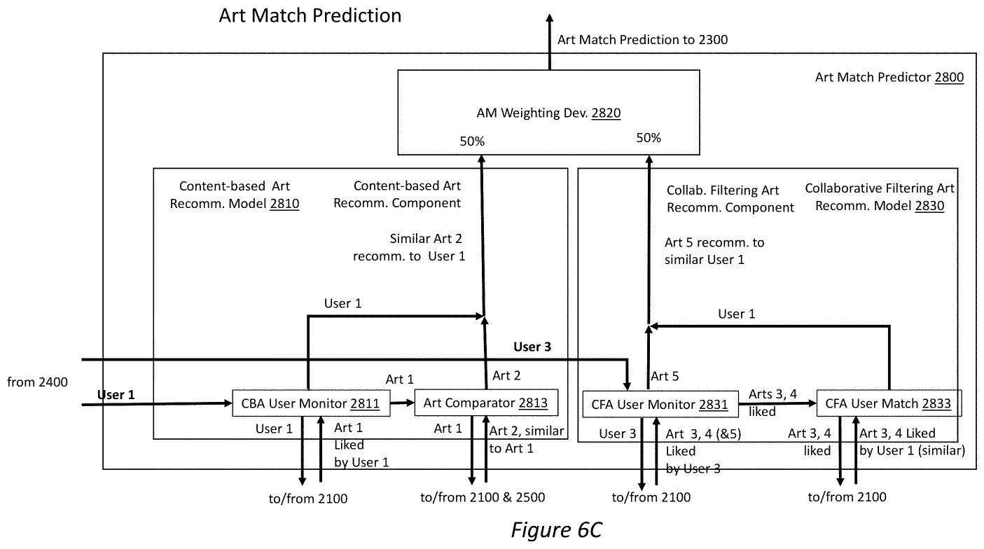

A more detailed description of the elements of the Art Match Predictor 2800 and its functions relating to suggesting art to users is provided in connection with the description of FIG. 6C below.

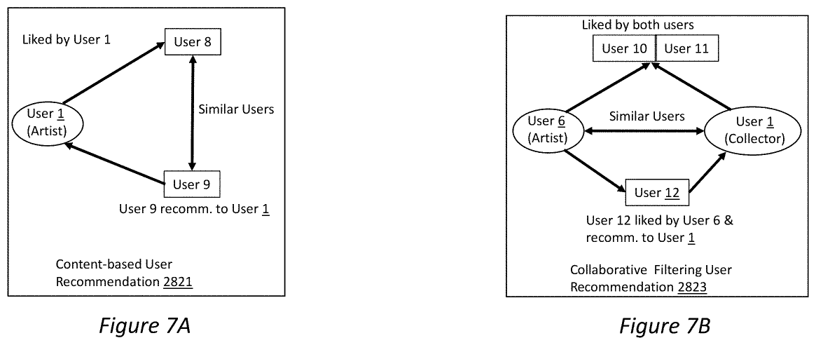

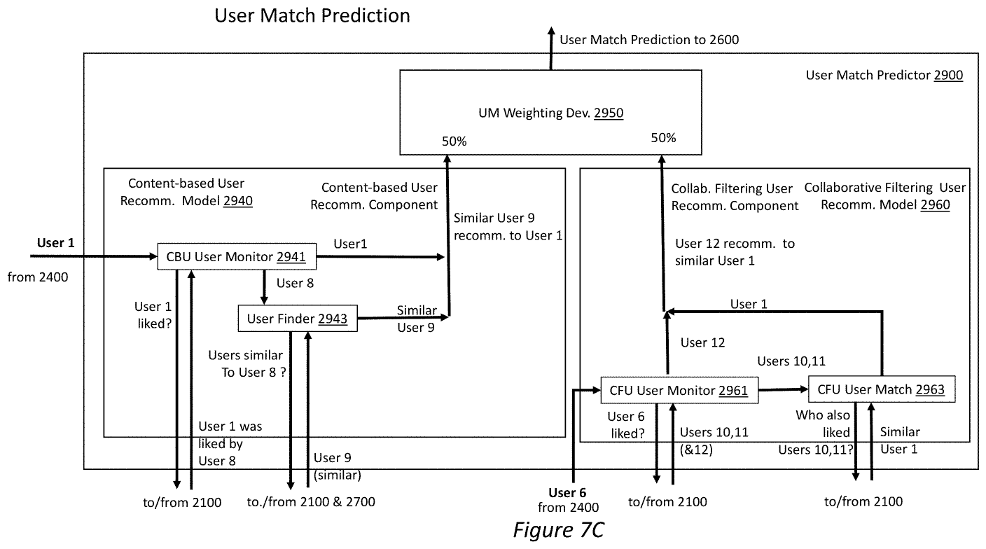

A more detailed description of the elements of the User Match Predictor 2900 and its functions relating to matching users is provided in connection with the description of FIG. 7C below.

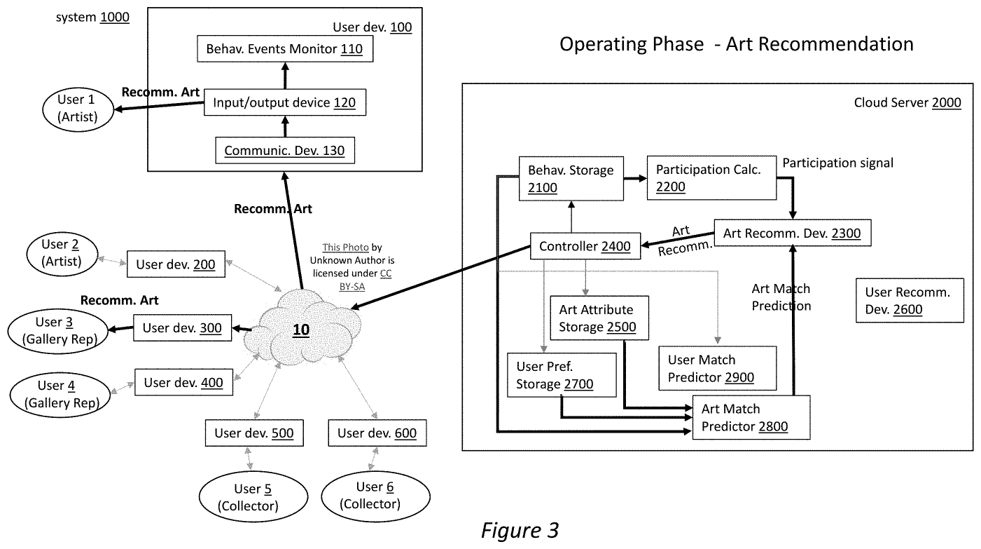

### FIG. 3

FIG. 3 is a simplified block diagram of one embodiment of a system according to the current invention illustrating the ‘art recommendation process’ of the ‘operating phase’ for the for Artists and Gallery Reps.

In FIG. 3 Participation Calculator 2200 extracts behavior information for each user that was previously stored in the Behavior Storage2100. Participation Calculator 2200 functions as shown in the more detailed illustration in FIG. 5.

Participation Calculator 2200 creates a Participation Score which is sent as a signal to Art Recommendation Device 2300.

Information regarding the User Preference attributes for each user that were previously stored in the User Preference Storage 2700 as described in FIG. 1A, are provided to the Art Match Predictor 2800.

Art Match Predictor 2800 then creates a component of an Art Recommendation and sends it in a signal to Art Recommendation Device 2300.

Art Match Predictor 2800 extracts art attributes previously stored in Art Attribute Storage 2500 and user preferences relating to art attributes that were also previously stored in User Preference Storage 2700. (The elements of Art Match Predictor 2800 are described in greater detail in connection with FIG. 6C below. The functioning of Match Predictor 2800 is also described in greater detail in connection with FIG. 6C below.)

The output signal of Art Match Predictor 2800 is an art recommendation score component based upon a weighted averaging of a Content-based model and a collaborative filtering model for calculating recommendations.

Art Recommendation Device 2300 receives the outputs of Participation Calculator 2200 and from Art Match Predictor 2800 and calculates an Art Recommendation that is provided to Controller 2400. Controller 2400 acquires the recommended piece of art from Art Attribute Storage 2500 and provides it to User 1 (Artist) via network 10, and User Device 100. This piece of art is displayed on Input/Output Device 120 of User Device 100.

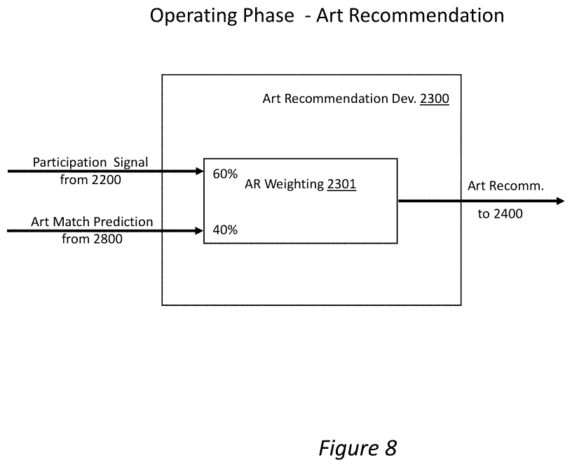

Art Recommendation Device 2300 is explained more fully below with reference to FIG. 8.

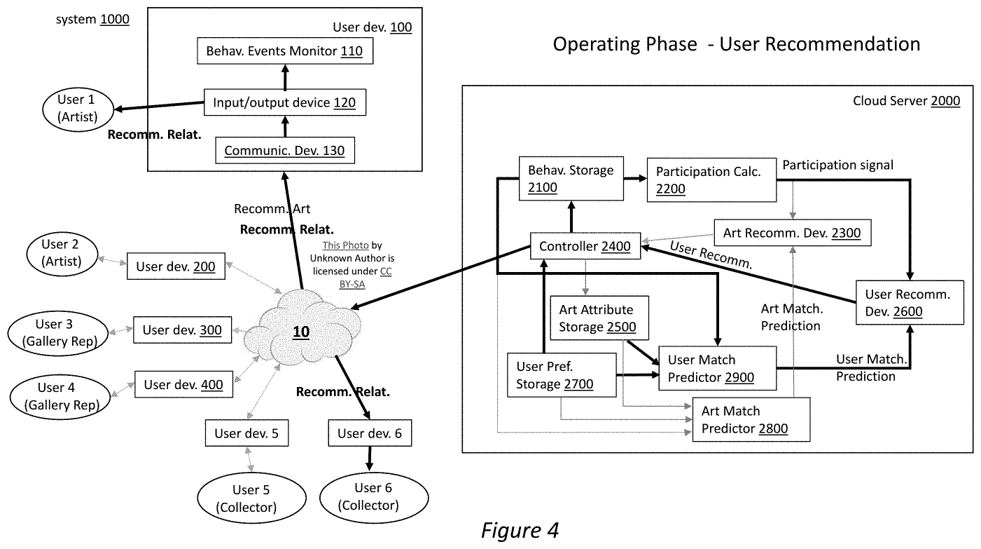

### FIG. 4

FIG. 4 is a simplified block diagram of one embodiment of a system according to the current invention illustrating the ‘user recommendation process’ of the ‘operating phase’.

User Match Predictor 2900 extracts previously stored user profiles from User Preference Storage 2700. User Match Predictor 2900 also extracts previously stored art attributes relating to the user from the Art Attribute Storage 2500.

User Match Predictor 2900 calculates a component of the User Match Prediction and sends it to use User Recommendation Device 2600.

Participation Calculator 2200 extracts previously stored behavior information for the Current User from Behavior Storage 2100. (Participation Calculator 2200 is described in more detail in FIG. 5. It is also described in more detail in connection with FIG. 5 below.)

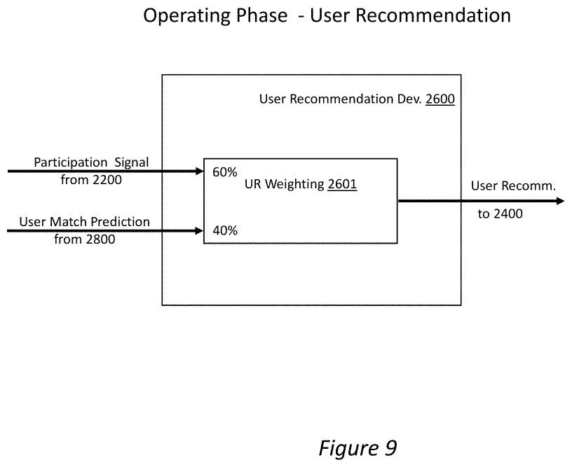

The output of Participation Calculator 2200 is a Participation Signal which is provided to User Recommendation Device 2600 that is shown and described in more detail in connection with FIG. 9.

### FIG. 5

FIG. 5 is a more detailed block diagram of the Participation Calculator 2200 of FIGS. 1A-4.

As described earlier, Controller 2400 interacts with the users acting through their User Devices 100-600 to provide behavior information which is then provided to Controller 2400 of Cloud Server 2000. Controller 2400 then stores this information in Behavior Storage 2100.

The behavior information stored by Controller 2400 falls into the dimensions of a) Engagement Attributes 2101, b) Cooperation Attributes 2103 and c) Action Attributes 2105.

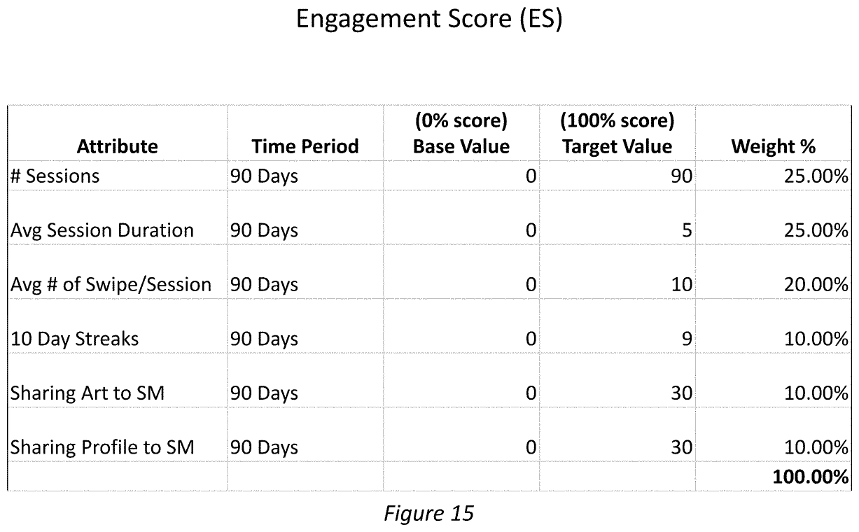

The Participation Calculator 2200 has an Engagement Calculator 2201 that extracts the Engagement Attributes 2101 and processes them. To calculate the score for the engagement dimension, we first define the following vectors as shown in FIG. 15:
weightᵢ the weighting for attribute i (all entries sum to 100%)
xᵢ the user's observed value for attribute i
lowerᵢ the x value representing a base value that is a 0% score for attribute i (value of attribute i=0.00)
upperᵢ the x value representing a target value that is a 100% score for attribute i
(value of attribute i=1.00)

Then to compute the Engagement Score (ES), we use the formula:

ES=Σᵢ₌1ⁿweightᵢ*max(0,min(1,(xᵢ−lowerᵢ)*1/(upperᵢ−lowerᵢ))) (Eq. 1)

The weights of the Engagement Attributes 2101 within FIG. 15, were set based on the expertise of the inventors to favor the most common engagement behaviors within the system. Future tests will be conducted to refine and improve the weighting. In an alternate embodiment, these weights may be set differently.

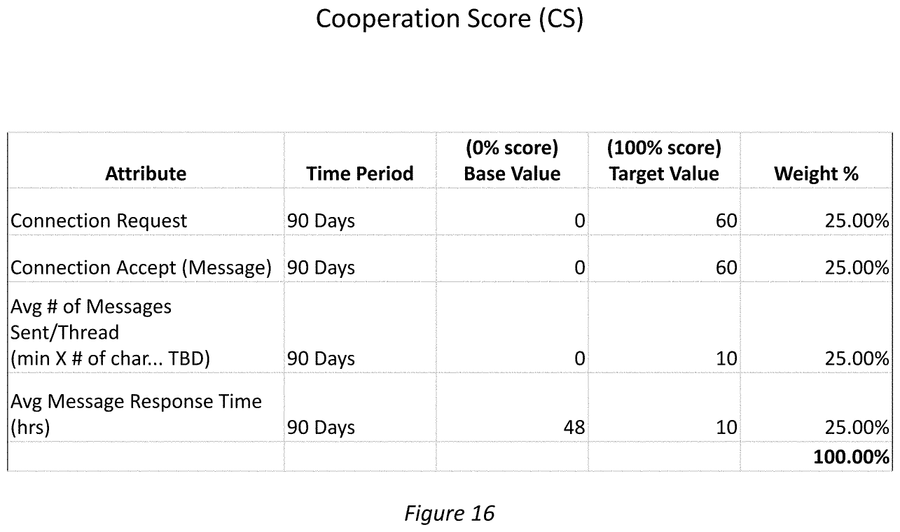

Similarly, a Cooperation Calculator 2205 extracts the Cooperation Score attributes 2103 from Behavior Storage 2100 and processes that information. To calculate the score for the cooperation dimension, we first define the following vectors as shown in FIG. 16:
weightᵢ the weighting for attribute i (all entries sum to 100%)
xᵢ the user's observed value for attribute i
lowerᵢ the x value representing a base value that is a 0% score for attribute i (value of attribute i=0.00) upperᵢ the x value representing a target value that is a 100% score for attribute i
(value of attribute i=1.00)

Then to compute the Cooperation Score (CS), we use the formula:

CS=Σᵢ₌1ⁿweightᵢ*max(0,min(1,(xᵢ−lowerᵢ)*1/(upperᵢ−lowerᵢ))) (Eq. 2)

The weights of the Cooperation Attributes 2103 within FIG. 16, were set based on the expertise of the inventors to give equal importance to all attributes given the role they play in establishing cooperation. Future tests will be conducted to refine and improve the weighting. In an alternate embodiment, these weights may be set differently.

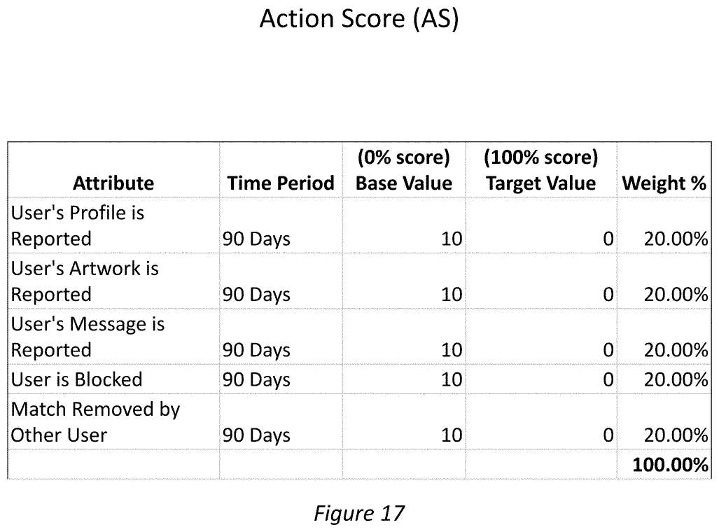

Similarly, an Action Calculator 2207 extracts the Action Score attributes 2105 from Behavior Storage 2100 and processes that information. To calculate the score for the action dimension, we first define the following vectors as shown in FIG. 17:
weightᵢ the weighting for attribute i (all entries sum to 100%)
xᵢ the user's observed value for attribute i
lowerᵢ the x value representing a base value that is a 0% score for attribute i (value of attribute i=0.00)
upperᵢ the x value representing a target value that is a 100% score for attribute i (value of attribute i=1.00)

Then to compute the Action Score (AS), we use the formula:

AS=Σᵢ₌1ⁿweightᵢ*max(0,min(1,(xᵢ−lowerᵢ)*1/(upperᵢ−lowerᵢ))) (Eq. 3)

The weights of the Action Attributes 2105 within FIG. 17, were set based on the expertise of the inventors to give equal importance to all attributes given the role these actions play in helping to prevent abuse from user-generated content. Future tests will be conducted to refine and improve the weighting. In an alternate embodiment, these weights may be set differently.

The output of Engagement Calculator 2201 is provided to a Weighting and Calculation Device 2209. Similarly, Cooperation Calculator 2205 provides its output to Weighting and Calculation Device 2209. Action Calculator 2207 also provides its output to the Weighting and Calculation Device 2209.

The weights of Weighting & Calculation Device 2209 were set based on the expertise of the inventors, to favor behaviors that contribute to Engagement and Cooperation over Action since those behaviors are more prevalent. Future tests will be conducted to refine and improve the weighting. In an alternate embodiment, these weights may be set differently.

The Weighting and Calculation Device 2209 weights and calculates the Participation Score using the following formula:

PARTICIPATION SCORE=(ES*40%)+(CS*40%)+(AS*20%) (Eq. 4)

### FIG. 6A

FIG. 6A is an illustration of the functioning of a Content-based Recommendation Logic 2801 which is used with the current invention for making a component of each recommendation. In this model, User 1, who is an Artist, likes a piece of art, labelled “Art 1”. In practice, Art 1 can represent a collection of art that the User 1 has previously liked.

The Content-based Recommendation Logic 2801 then determines which other pieces of art are similar to Art 1. Similarity can be determined based on the pattern of likes. Once User 1 likes enough art, we can observe patterns that exhibit which attributes are important to User 1.

The piece of art, “Art 2”, is determined to be similar to Art 1 because it exhibits the same or similar attributes. The Content-based Recommendation Logic 2801 then recommends art piece Art 2 to User 1 based on the similarities between Art 2 and Art 1.

### FIG. 6B

FIG. 6B is an illustration of the functioning of a Collaborative Filtering Art Recommendation Logic 2803 which is used with the current invention.

In FIG. 6B, User 3, who happens to be an Artist, likes art pieces, Art 3 and Art 4. In this example, User 1, which happens to be a Gallery Rep also, likes the same pieces of art, Art 3 and Art 4. Similarity in this example is determined by the overlaps in liking Art 3 and Art 4, though in practice, similarity can also be determined based on ‘likes’ pertaining to a collection of art.

Therefore, if User 3 then liked Art 5, it is determined that Art 5 will probably be a piece of art that should be recommended to User 1 based on the similarities between User 3 and User 1. Collaborative Filtering Art Recommendation Logic 2803 then recommends Art 5 to User 1

### FIG. 6C

FIG. 6C is a more detailed illustration of the elements of the Art Match Predictor used to recommend art of FIGS. 1A-4.

In FIG. 6C, both a Content-based Art Recommendation Model 2810 and a Collaborative Filtering Art Recommendation Model 2830 are employed. Each of these provides a component that is used to make recommendations. Content-based Art Recommendation Model 2810 creates a Content-based recommendation component and Collaborative Filtering Art Recommendation Model 2830 creates a collaborative filtering recommendation component.

These components are merged by an AM Weighting Device 2820 to provide an art recommendation that is sent to Art Recommendation Device 2300.

The weights of AM Weighting Device 2820 were set based on the expertise of the inventors, to not favor either the Content-based Art Recommendation Model 2810 or the Collaborative Filtering Art Recommendation Model 2830 since both methods have strengths and weaknesses. Future tests will be conducted to refine and improve the weighting. In an alternate embodiment, these weights may be set differently.

The Content-based Art Recommendation Model 2810 functions in a similar way to the Content-based Logic 2801 illustrated in FIG. 6A.

Similarly, the Collaborative Filtering Art Recommendation Model 2830 functions in a similar way to the Collaborative Filtering Logic 2803 shown in FIG. 6B.

A CBA User Monitor 2811 receives a user number of a user intended to receive an art recommendation. In this example, it is User 1. CBA User Monitor 2811 searches through Behavior Storage 2100 to find that Art 1 that was liked by User 1. CBA User Monitor 2811 provides the indication of Art 1 to an Art Comparator 2813.

Art Comparator 2813 then searches through the Behavior Storage 2100 and Art Attributes Storage 2500 to find art which is similar to Art 1. This is done by comparing previous likes stored in Behavior Storage 2100, and stored attributes relating to the pieces of art in Art Attribute Storage 2500 to identify which are similar. Most conventional methods may be applicable here.

One of the pieces of art which was determined to be similar to Art 1, in this example is Art 2. Art 2 is intended to be recommended to User 1 as the Content-based Art Recommendation Component and is sent to the AM Weighting Device 2820.

In the Collaborative Filtering Art Recommendation Model 2830, a CFA User Monitor 2831 receives a user number of a user intended to receive a recommendation. In this example, it is User 3. CBA User Monitor 2811 searches through Behavior Storage 2100 to find pieces of art, Art 3, 4 that were liked by User 3. CBA User monitor 2811 provides the indication that User 3 has liked Art 3, 4 to a CFA User Match device 2833.

CFA User Match device 2833 searches Behavior Storage 2100 for other Users that have liked Art 3, 4. User 1 is found to be one of the users that has liked Art 3, 4. Based upon this similarity (and possibly other similarities) it is determined that User 3 and User 1 are similar users.

CFA User Monitor 2831 also searches Behavior Storage 2100 to find other art pieces that User 3 has liked. It returns Art 5 (in addition to Art 3, 4 previously returned). Art 5 is then recommended to User 1 as a Collaborative Filtering Art Recommendation Component to AM Weighting Device 2820, since it was determined that Users 1 and 3 were similar users.

If the recommendation components are for the same User, then the Content-based Art Recommendation component is multiplied by “50%” to weight it. Similarly, the Collaborative Filtering component is multiplied by “50%” to weight it and added to the weighted Content-based Art Recommendation component to result in an art recommendation which is sent to Art Recommendation Device 2300. In alternative embodiments, the weighting values may be adjusted to make either the Content-based Model or the Collaborative Filtering Model dominant.

### FIG. 7A

FIG. 7A is an illustration of the functioning of a Content-based User Recommendation Logic 2821 which is used with the current invention for making user recommendations.

In this model, User 1, who is an Artist, has previously liked User 8. In practice, user 8 can represent a collection of other users that User 1 has previously liked.

The Content-based User Recommendation Logic 2821 then determines which other users are similar to User 8. Similarity can be determined based on the pattern of likes. Once User 1 likes enough others users, we can observe patterns that exhibit which preferences are important to User 1.

User 9 is determined to be similar to User 8 because they exhibit the same or similar preferences. The Content-based User Recommendation Logic 2821 then recommends User 9 to User 1 based on the similarities between User 8 and User 9.

### FIG. 7B

FIG. 7B is an illustration of the functioning of a Collaborative Filtering User Recommendation Logic 2823 which is used with the current invention for making user recommendations. In FIG. 7B, User 6, who happens to be an Artist, liked both User 10 and User 11. User 1, which happens to be a Gallery Rep, was also liked User 10 and User 11.

Similarity in this example is determined by the overlaps in liking User 10 and User 11, though in practice, similarity can also be determined based on likes pertaining to a collection of users.

Therefore, if User 6 liked User 12, it is determined that User 12 should be recommended to User 1 as a match based on the similarities between User 6 and User 1. Collaborative Filtering User Recommendation Logic 2823 then recommends User 12 to User 1.

### FIG. 7C

FIG. 7C is a more detailed illustration of the elements of the User Match Predictor 2900 used to recommend users of FIGS. 1A-4. FIG. 7C employs both a Content-based User Recommendation Model 2940 and a Collaborative Filtering User Recommendation Model 2960 are employed for recommending a user match. Each of these models provides a component that is used to make user recommendations. Content-based User Recommendation Model 2940 creates a Content-based User Recommendation component. Collaborative Filtering User Recommendation Model 2960 creates a Collaborative Filtering User Recommendation Component.

In this example, Content-based User Recommendation Component is multiplied by “50%” to weight it. The Collaborative Filtering User Recommendation Component is multiplied by “50%” to weight it.

These weighted components are merged by a UM Weighting Device 2950 to provide a recommendation that is sent to Art Recommendation Device 2300.

The weights of UM Weighting Device 2950 were set based on the expertise of the inventors, to not favor either the Content-based Art Recommendation Model 2940 or the Collaborative Filtering Art Recommendation Model 2960 since both methods have strengths and weaknesses. Future tests will be conducted to refine and improve the weighting. In an alternate embodiment, these weights may be set differently.

The Content-based User Recommendation Model 2940 functions in a similar way to the Content-based User Recommendation Logic 2821 illustrated in FIG. 7A.

Similarly, the Collaborative Filtering User Recommendation Model 2960 functions in a similar way to the Collaborative Filtering User Recommendation Logic 2823 shown in FIG. 7B.

A CBU User Monitor 2941 of Content-based User Recommendation Device 2940 receives a user number of a user intended to receive a user recommendation. In this example, it is User 1. CBU User Monitor 2941 then searches through the Behavior Storage 2100 to find users which are similar to User 1 based on previous likes. CBU User Monitor 2941 then provides the indication of the previous like between User 1 and User 8 to a User Finder 2943.

User Finder 2943 then searches through the Behavior Storage 2100 and User Preference Storage 2700 to find users which are similar to User 8. This is done by comparing previous likes stored in Behavior Storage 2100, and stored preferences relating to the users in User Preference Storage 2700 to identify which are similar. Most conventional methods may be applicable here.

One of the users determined to be similar to User 8 is User 9. This may be done by comparing one or more of the stored fields relating to the pieces of art and providing an indication of which have the most similarity. Most conventional methods would be applicable here. User 9 is then recommended to User 1 as the Content-based User Recommendation Component.

The Content-based User Recommendation Component is sent to the Weighting Device 2850 and is weighted by multiplying it by “50%”.

On the right side of FIG. 7C, shows the Collaborative Filtering User Recommendation Model 2960. A CFU User Monitor 2961 receives an indication of an initial user to process from Controller 2400, being User 6. CFU User Monitor 2961 then searches Behavior Storage 2100 for previous likes to User 6. It returns that users 10, 11 were previously liked by User 6. CFU User Monitor 2961 then sends an indication of Users 10 and 11 to a CFU User Match 2963 which searches Behavior Storage 2100 looking for users who had previously liked Users 10 and 11. This search results in User 1. Therefore, it is assumed that User 1 is similar to User 6, based, at least upon previous likes.

CFU User Monitor 2961 then searches 2100 again to find another user previously liked User 6, being user 12. User 12 is now recommended to User 1 as the Collaborative Filtering User Recommendation Component.

The Collaborative Filtering User Recommendation Component is sent to the UM Weighting Device 2950 and is weighted by multiplying it by “50%”. The weighted components are added to create a Preliminary User Match Prediction signal.

### FIG. 8

FIG. 8 is a more detailed block diagram of the Art Recommendation Device 2300 of FIGS. 1-4. In FIG. 8, an AR Weighting Device 2301 receives the Participation Score (signal) from Participation Calculator 2200 and weights it by multiplying it by “60%”.

AR Weighting Device 2301 also receives the Art Match Predictor Signal from Art Match Predictor 2800 and weights it by multiplying it by “40%”.

The weights in AR Weighting 2301 were set based on the expertise of the inventors, to favor the Participation Signal from 2200 over the Art Match Prediction from 2800 to counter the issues of capital and popularity bias that produce the runaway “winner-takes-all” issues of known recommender systems. Future tests will be conducted to refine and improve the weighting. In an alternate embodiment, these weights may be set differently.

The resulting products are then added to result in an Art Recommendation Signal that is sent to Controller 2400.

### FIG. 9

FIGS. 9 is a more detailed block diagram of the User Recommendation Device 2600 of FIGS. 1-4. In FIG. 9, a UR Weighting Device 2601 receives the Participation Signal (signal) from Participation Calculator 2200 and weights it by multiplying it by “60%”.

UR Weighting Device 2601 also receives the User Match Predictor Signal from User Match Predictor 2800 and weights it by multiplying it by “40%”.

The weights in UR Weighting 2601 were set based on the expertise of the inventors, to favor the Participation Signal from 2200 over the Art Match Prediction from 2800 to counter the issues of capital and popularity bias that produce the runaway “winner-takes-all” issues of known recommender systems. Future tests will be conducted to refine and improve the weighting. In an alternate embodiment, these weights may be set differently.

The resulting products are then added to result in a User Recommendation that is sent to Controller 2400.

Adjusting the relative weights in alternative embodiments adjusts the effect that participation has on the ultimate recommendations. These weights can be experimentally adjusted to provide the desired amount of participation influence. Once the weights are adjusted, they are held constant for all users.

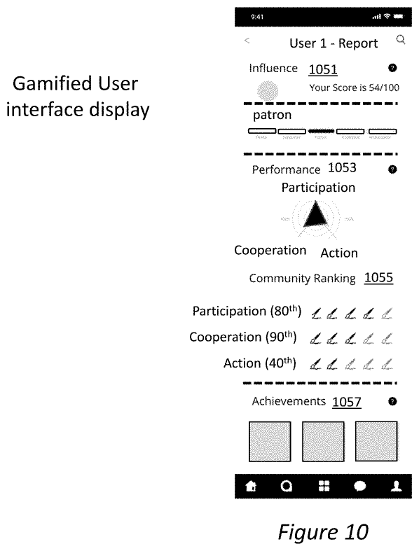

### FIG. 10

FIG. 10 is an illustration of a display of a user Device showing a user interface that provides feedback to users on how their Participation Score is modifying their overall influence within the Participatory Recommender System.

This screen has four sections reporting on a) 1051 Participation Score, referred to as Influence in the design, b) 1053 Performance, c) 1055 Community Rankings, and d) 1057 Achievements.

The Influence section 1051 displays an example Participation Score of 54 out of 100. This is similar to a percentile number indicating that a 50 would mean User 1 is at the center of a bell curve distribution of all users. Users can fall within five percentile ranges Friend (1-20%), Supporter (21-39%), Patron (40-60%), Champion (41-80%), and Ambassador (81-100%). In FIG. 10, the user is in the Patron range since their score is 54.

Performance section 1053 of FIG. 10 is a radar chart with the three axes (poles) displays the three dimensions of performance being the Engagement Score (ES), Eq. 1, Cooperation Score (CS), Eq. 2, and Action Score (AS), Eq. 3. In this chart, a user's performance in each of those dimensions is graphed to provide visual feedback as to how they are performing in the three dimensions that make up the Participation Score (Influence).

Community Ranking 1055, which is display on a community leaderboard, uses the same scores of the radar chart section 1053, except that these are shown as a percentile ranking based on the user's performance compared to the entire community user base.

The Achievements section 1057 shows icons or badges when past performance exceeds a defined milestone. For example, when a user swipes on 100 pieces of art, he/she will receive a badge which is displayed in the Achievements section 1057.

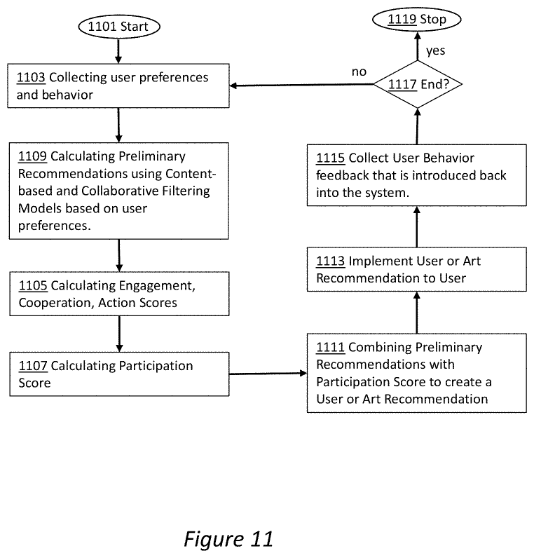

### FIG. 11

FIG. 11 is flowchart illustrating the participatory function of the Gamified Participatory Recommender System according to one embodiment of the current invention. FIG. 11 illustrates a method of combining a Participation Score with existing methods of recommender systems to produce the Participatory Recommender System 1000. The process starts at step 1101.

Next, in step 1103, user preferences and user behavior are collected and stored.

In step 1105, the user preferences are fed into a Content-based Recommendation Model and a Collaborative Filtering Recommendation Model (2810 2830 of FIG. 6C, respectively), to create an Art Match Prediction and a User Match Prediction.

Concurrently in step 1107, user behavior is analyzed to create Engagement, Cooperation, and Action Scores.

In step 1109, the scores from 1107 are rolled up into an overall Participation Score (Signal).

In step 1111 the Participation Signal from step 1107 is joined with the Art Match Prediction to create an Art Recommendation. The Participation Signal and the User Match Prediction are combined to create a User Recommendation.

In step 1113 the Recommended Art indicated in the Art Recommendation is displayed to the Current User. Also, a link to the Recommended User indicated in the User Recommendation is created and sent to the Current User, allowing the Current User to contact the Recommended User. This System 1000 may also provide at least some of the User Profile or User Preferences of either or both the Current User and the Recommended User to the other user as part of an introduction.

In step 1115, feedback is collected based on their interaction with the recommended art or user, and that feedback is fed back into the Participatory Recommender System, to iteratively adjust the Gamified Participatory Recommender System 1000.

In step 1117, it is determined if the user would like to stop the system. If so (“yes”), then the process then ends at step 1119. If not (“no”), then the process continues at step 1103.

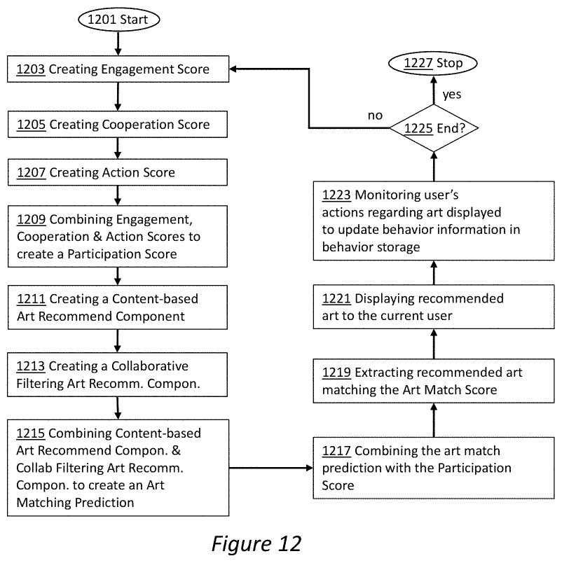

### FIG. 12

FIG. 12 is a flow chart illustrating a method of recommending art based on a Participation Score combined with existing recommendation methods. The process starts at step 1201.

Next, in step 1203, in Engagement Calculator 2201 employs Engagement Attributes 2101 for a Current User as indicated that were previously acquired and stored in Behavior Storage 2100 and processes them to determine an Engagement Score, as previously described above with reference to Eq. (1).

Similarly, in step 1205, Cooperation Attributes 2103 previously stored in Behavior Storage 2100 are processed by Cooperation Calculator 2205 to create a Cooperation Score, as indicated above in Eq. (2).

In step 1207, the Action Attributes 2105 previously stored in Behavior Storage 2100 are processed by Action Calculator 2207 to create an Action Score, in the same manner as described above for Eq. (3).

In step 1209 the Engagement Score (ES), Cooperation Score (CS) and Action Score (AS) are combined into a Participation Score.

In step 1211, a Content-based Art Recommendation Model 2810 creates a Content-based Art Recommendation Component from information extracted from Behavior Storage 2100 and Art Attribute Storage 2500.

In step 1213, a Collaborative Filtering-based Art Recommendation Model 2810 creates a Collaborative Filtering Art Recommendation Component from information extracted from Behavior Storage 2100.

In step 1215, combining the Content-based Art Recommendation Component and the Collaborative Filtering Art Recommendation Component in AM Weighting Device 2820 to result in an Art Match Prediction for the Current User;

In step 1217, by combining the Art Match Prediction with the Participation Signal, Art Recommendation Device 2300 creates an Art Recommendation, recommending Art to the Current User;

In step 1219, Controller 2400 extracts the recommended art from the Art Attributes Storage 2500.

In step 1221, the extracted Art is displayed to User Device 100 and the Current User (1).

In step 1223, the Current User's actions are monitored regarding the Art displayed by a Behavior Events Monitor 110 and sent to Behavior Storage 2100 for use in future calculations.

In step 1225, it is determined if the Current User would like to stop the system. If so (“yes”), then the process then ends at step 1227. If not (“no”), then the process continues at step 1203.

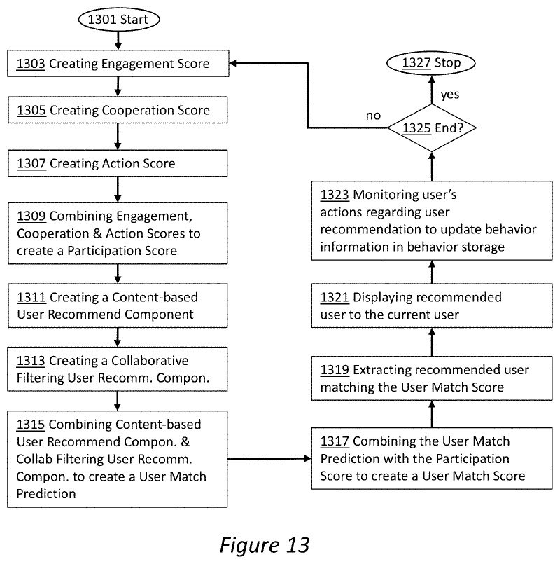

### FIG. 13

FIG. 13 is flowchart illustrating the user recommendation function of the Gamified Participatory Recommender System according to one embodiment of the current invention. FIG. 13 illustrates a method of recommending a user based on a Participation Score combined with two different recommendation models.

The process begins at step 1301.

Next, in step 1303, an Engagement Calculator 2201 reads Engagement Attributes 2101 for a Current User that were previously acquired and stored in Behavior Storage 2100 and processed them to determine an Engagement Score (ES), as previously described above in Eq. (1).

Similarly, in step 1305, Cooperation Attributes 2103 in Behavior Storage 2100 is processed by Cooperation Calculator 2205 to create a Cooperation Score (CS) as describe in Eq. (2).

In step 1307, Action Attributes 2105 in Behavior Storage 2100 are processed by Action Calculator 2207 to create an Action Score (AS), all in the same manner as described above for Eq. (3).

In step 1309 the Engagement, Cooperation and Action Scores are combined into a Participation Score.

In step 1311, a Content-based User Recommendation Model 2810 creates a Content-based User Recommendation Component from information extracted from User Preference Storage 2100.

In step 1313, a Collaborative Filtering User Recommendation Model creates a Collaborative Filtering User Recommendation Component from the information extracted from the Behavior Storage 2100.

In step 1315, a Collaborative Filtering User Recommendation Model 2830 creates a Collaborative Filtering User Recommendation Component from information extracted from Behavior Storage 2100.

In step 1315, combining the Content-based User Recommendation Component and the Collaborative Filtering User Recommendation Component in a UM Weighting Device 2950 to result in a User Match Prediction for the Current User;

In step 1317, User Recommendation Device 2600 combines the User Match Prediction with the Participation Score, to create a User Recommendation, recommending a user to the Current User;

In step 1319, employing a Controller 2400 to extracts contact information relating to the recommended user from the Art Attributes Storage 2500.

In step 1321, displaying the extracted user to a User Device 100 to the Current User (1).

In step 1323, the Current User's actions are monitored regarding the user displayed by a Behavior Events Monitor 110 and sent to Behavior Storage 2100 for use in future calculations.

In step 1325, it is determined if the user would like to stop the system. If so (“yes”), then the process then ends at step 1327. If not (“no”), then the process continues at step 1303.

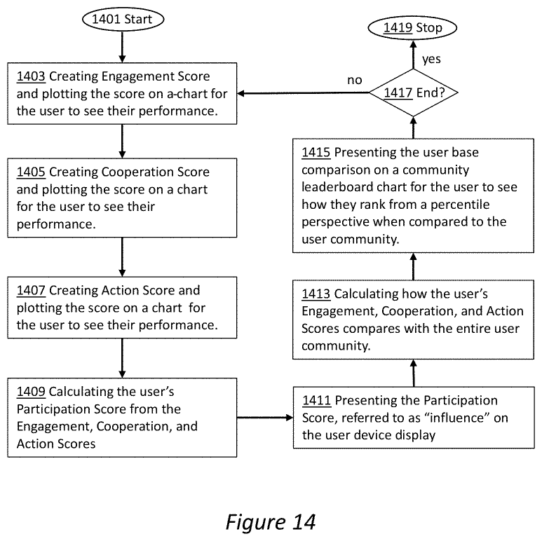

### FIG. 14

FIG. 14 is flowchart illustrating the gamified function of the Recommender System according to one embodiment of the current invention. FIG. 14 illustrates a method of presenting gamified feedback to a user based on their overall Participation Score and individual engagement, cooperation, and actions scores, so that the user can learn from the feedback and adjust their behavior with the goal of improving their Participation Score and increasing the chances that their art and user profile are recommended more to other users. The method demonstrates how to produce a Gamified Participatory Recommender System. The process starts at step 1401.

Next, in step 1403, in Engagement Calculator 2201, engagement information 2101 for a Current User that was previously acquired and stored in Behavior Storage 2100 is processed to determine an Engagement Score (ES), as previously described above.

Similarly, in step 1405, Cooperation Attributes 2103 in Behavior Storage 2100 are processed by Cooperation Calculator 2205 to create a Cooperation Score.

In step 1407, Action Attributes 2105 in Behavior Storage 2100 are processed by Action Calculator 2207 to create an Action Score (AS), all in the same manner as described above in Eq. (3).

In step 1409 the Engagement, Cooperation and Action Scores are combined into a Participation Score.

In step 1411 the Participation Score is presented to the user, (referred to as “influence” on the user Device display), on a scale from 0-100 for the user to see how they are performing as an Entity.

In step 1413 the Engagement, Cooperation and Action Scores are compared to the entire user base.

In step 1415 the Engagement, Cooperation and Action Scores are presented to the user, on a community leaderboard, for the user to see how they rank from a percentile perspective when compared to the community user base.

In step 1417, it is determined if the user would like to stop the system. If so (“yes”), then the process then ends at step 1419. If not (“no”), then the process continues at step 1403.

### FIG. 15

FIG. 15 is a table displaying the attributes, time period, base value, target value, and weighting that is used to calculate the Engagement Score (ES), in (Eq. 1) above.

### FIG. 16

FIG. 16 is a table displaying the attributes, time period, base value, target value, and weighting that is used to calculate the Cooperation Score (CS) in (Eq. 2) above.

### FIG. 17

FIG. 17 is a table displaying the attributes, time period, base value, target value, and weighting that is used to calculate the Action Score (AS) in (Eq. 3) above.

### ALTERNATIVE EMBODIMENTS

It is well within the spirit of this invention to use other recommendation models besides Collaborative Filtering and Content-Based Filtering models. Examples may also include popularity-based models, classification models, deep learning, neural networks models or combinations thereof. Such models can be implemented using systems such as Amazon Personalize.

The preferences, attributes and weights used to adjust the Engagement, Cooperation and Action Scores in the above description are provided as one specific example of an implementation of the current system. However, it is understood that adjustment of these preferences, attributes, and weights will cause the system to operate in a slightly different manner. For example, one may provide a higher relative weight for the Cooperation Score to reward those users which cooperate more than the other users. These weights and parameters may be iteratively adjusted to determine a desired performance of the system, but all will fall under the spirit of the invention as disclosed in this application.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant reserves the right to physically incorporate into the written description or any other portion of the application, any and all such claims. Thus, for example, under no circumstances may the patent be interpreted as allegedly not providing a written description for a claim on the assertion that the precise wording of the claim is not specifically set forth in the written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps and are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. Accordingly, the description herein above is not intended to limit the invention, except as indicated in the appended claims.

Therefore, provided herein is a new and improved system and method for scheduling and performing maintenance and/or repair on electrical equipment

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the foregoing aspects are illustrative, and no single feature or element essential to all possible combinations may be claimed in this or a later application.

We claim:

1. A system for iteratively providing Art to a User 1 to view and linking User 1 to a similar Recommended User comprising:
a Behavior Events Monitor in a User Device that monitors behavior of User 1 and sends the Monitored User Behavior to a Controller in a Cloud Server that stores it in a Behavior Storage in the Cloud Server;
a Participation Calculator that reads the Monitored User Behavior from the Behavior Storage and uses it to create a Participation Signal;
an Art Match Predictor that receives previously stored Monitored User Behavior from the Behavior Storage and previously stored User Preferences from a User Preference Device and previously stored Art and Art Attributes from an Art Attribute Storage and employs these to determine similar art to the art liked by the Current User and creates an Art Match Prediction of similar Art;
an Art Recommendation Device that receives the Participation Signal from the Participation Calculator and also receives the Art Match Prediction Signal from the Art Match Predictor and determines an Art Recommendation indicating a piece of Recommended Art to display to the Current User;
a User Match Predictor that receives previously stored Monitored User Behavior from the Behavior Storage and previously stored User Preferences from the User Preference Device 2700 and previously stored Art Attributes from an Art Attribute Storage and employs these to determine a User Match Prediction Signal indicating a user similar to User 1;
a User Recommendation Device is coupled to the Participation Calculator that receives a Participation Signal from the Participation Score Calculator and receives the User Match Prediction Signal from the User Match Predictor and determines a user which is most similar to User 1;
a Controller receives an indication of the Recommended Art to display to the Current User from the Art Recommendation Device, and extracts the Recommended Art from the Art Attribute Storage and provides it to the User Device;
wherein the User Device 100 displays the Recommended Art on an Input/Output device to User 1;
wherein the Controller also receives an indication of the Recommended User from the User Recommendation Device, creates a link to the Recommended User and provides this link to User 1 allowing the User 1 to connect with, and message the Recommended User.

2. The system of claim 1, wherein the Participation Calculator comprises:
an Engagement Calculator which creates an Engagement Signal (ES) based upon a combination of Engagement Attributes of User 1;
a Cooperation Calculator which creates a Cooperation Signal (CS) based upon a combination of Cooperation Attributes of User 1;
an Action Calculator which creates an Action Signal (AS) based upon a combination of Action Attributes of User 1; and
a Weighting and Calculation Device that receives the Engagement Signal (ES), the Cooperation Signal (CS) and the Action Signal (AS), weights each and combines them into the Participation Signal.

3. The system of claim 1, wherein the Art Match Predictor comprises:
a Content-based Art Recommendation Model which creates a Content-based Art Recommendation Component; and
a Collaborative Filtering Art Recommendation Model which creates a Collaborative Filtering Art Recommendation Component; and
an AM Weighting Device which weights and combines the Content-based Art Recommendation Component with the Collaborative Filtering Art Recommendation Component to result in an Art Match Prediction for User 1.

4. The system of claim 3, wherein the Content-based Art Recommendation Model comprises:
a CBA User Monitor which receives an identification of User 1, and searches the Behavior Storage having a prestored list of previous art liked by the users, to find Art 1 previously liked by User 1;
an Art Comparator receives an indication of Art 1 previously liked by User 1 from the CBA User Monitor and searches the Behavior Storage and Art Attribute Storage to find at least one piece of art, such as Art 2, which is similar to the Art 1 that was liked by User 1. It then creates the Content-based Art Recommendation Component recommending Art 2 to User 1.

5. The system of claim 3, wherein the Collaborative Filtering Art Recommendation Model comprises:
a CFA User Monitor which receives an identification of a User 3, and searches the Behavior Storage having a prestored list of art liked by the users, to find pieces of art, Art 3 and Art 4, previously liked by User 3;
a CFA User Match which receives an indication of the Art 3, 4 previously liked by User 3 from the CFA User Monitor then searches the Behavior Storage for Art 3, 4 and finds that User 1 that also liked Art 3,4;
CFA User Monitor searches the Behavior Storage to find another piece of art, Art 5, previously liked by User 3;
wherein CFA User Match then creates the Collaborative Filtering Art Recommendation Component recommending Art 5 to User 1.

6. The system of claim 1, wherein the User Match Predictor comprises:
a Content-based User Recommendation Model which creates a Content-based User Recommendation Component; and
a Collaborative Filtering User Recommendation Model which creates a Collaborative filtering User Recommendation Component; and
a UM Weighting Device which weights and combines the Content-based User Recommendation Component with the Collaborative Filtering User Recommendation Component to result in a User Recommendation for User 1.

7. The system of claim 6, wherein the Content-based User Recommendation Model 2940 comprises:
a CBU User Monitor 2941 which receives an identification of a Current User being User 1, and searches the Behavior Storage having a prestored list of previous likes of users, to find that User 8 was previously liked by User 1;
a User Finder receives an indication of User 8 from the CBU User Monitor and searches the Behavior Storage and User Preference Storage for the Users liked by the User 1 to find at least one other user, such as User 9, which is similar to User 8. It then creates the Content-based User Recommendation Component which is a preliminary recommendation of similar User 9 to User 1.

8. The system of claim 6, wherein the Collaborative Filtering User Recommendation Model comprises:
a CFU User Monitor which receives an identification of a User 6, and searches the Behavior Storage having a prestored list of previous likes of users, to find Users 10 and 11 previously liked by User 6;
a CFU User Match which receives an indication of Users 10, 11 previously liked by User 6 from the CFU User Monitor 2961;
a CFU User Match searches Behavior Storage 2100 with Users 10,11, to find a User 1 that had similar likes;
wherein CFU User Monitor then searches Behavior Storage with User 6 to find User 12 which was previously liked by User 6;
wherein CFU User Match 2963 then creates a Collaborative Filtering User Recommendation Component used to recommend User 12 to User 1.

9. The system of claim 2, wherein the Engagement Calculator creates an Engagement Score (ES) based upon Engagement Attributes of a User within a defined period comprising at least one of:
a count of a number of sessions;
an average session duration;
an average number of swipes per session;
a number of streaks of use having at least a predetermined length;
a count of the number of times a user shared art with social media; and
a count of the number of times a user shared user profiles with to social media.

10. The system of claim 2, wherein the Cooperation Calculator creates a Cooperation Score (CS) based upon a combination of Cooperation Attributes of a User within a predetermined time period comprising at least one of:
a number of connection requests initiated;
a number of connection requests accepted;
an average number of messages sent per thread; and
an average message response time.

11. The system of claim 2, wherein the Action Calculator creates an Action Score (AS) based upon the values for a number of Action Attributes of a User within a predefined time period comprising at least one of:
a number of times a profile of User 1 is reported by another user;
a number of times artwork of Use 1 is reported by another user;
a number of times a message of User 1 is reported by another user;
a number of times User 1 was blocked by another user; and
a number of times User 1 was removed from user matches by another user.

12. The system of claim 9, wherein the Engagement Calculator calculates an Engagement Score (ES) according to the following equation:
ES=Σᵢ₌1ⁿweightᵢ*max(0,min(1,(xᵢ−lowerᵢ)*1/(upperᵢ−lowerᵢ))) (Eq. 1)
wherein:
n=number of attributes being used;
weightᵢ=percentage weighting for attribute i (all weights sum to 100%)
xᵢ=value of attribute i
lowerᵢ=the minimum possible value for attribute i; and
upperᵢ=the maximum possible value for attribute i.

13. The system of claim 9, wherein the Cooperation Calculator calculates a Cooperation Score (ES) according to the following equation:
CS=Σᵢ₌1ⁿweightᵢ*max(0,min(1,(xᵢ−lowerᵢ)*1/(upperᵢ−lowerᵢ))) (Eq. 2)
wherein:
n=number of attributes being used;
weightᵢ=percentage weighting for attribute i (all weights sum to 100%)
xᵢ=value of attribute i
lowerᵢ=the minimum possible value for attribute i; and
upperᵢ=the maximum possible value for attribute i.

14. The system of claim 9, wherein the Action Calculator calculates an Action Score (ES) according to the following equation:
AS=Σᵢ₌1ⁿweightᵢ*max(0,min(1,(xᵢ−lowerᵢ)*1/(upperᵢ−lowerᵢ))) (Eq. 3)
wherein:
weightᵢ=percentage weighting for attribute i (all weights sum to 100%)
xᵢ=value of attribute i
lowerᵢ=the minimum possible value for attribute i; and
upperᵢ=the maximum possible value for attribute i.

15. A method for incorporating a measure of user participation of a User 1 into a Participatory Recommender System to produce recommendations, comprising the steps of:
a. collecting Engagement Attributes, Cooperation Attributes and Action Attributes which indicate preferences and behavior information of User 1;
b. calculating a Content-based Art Recommendation Component and a Collaborative Filtering Art Recommendation Component at least partially from similarities between pieces of art and ‘likes’ indicated by User 1 and other users;
c. combining the Content-based Art Recommendation Component with the Collaborative Filtering Art Recommendation Component to create an Art Match Predictor;
d. calculating a Participation Signal from the Engagement, Cooperation and Action Attributes;
e. combining the Participation Signal with the Art Match Predictor to create an Art Recommendation Signal indicating Recommended Art;
f. acquiring Recommended Art indicated by the Art Recommendation Signal;
g. displaying the Recommended Art to User 1; and
h. collecting preferences and behavior as feedback of User 1 that is then iteratively fed back into the Participatory Recommender System and used in the above calculations.

16. The method of claim 15 further comprising the steps of:
a. calculating a Content-based User Recommendation Component from previous likes of users and similarities between users;
b. calculating a Collaborative Filtering User Recommendation Component from previous likes of users and similarities between users;
c. combining the Content-based User Recommendation Component with the Collaborative Filtering User Recommendation Component to create a User Match Prediction;
d. calculating a Participation Signal from the Engagement Score (ES), Cooperation Score (CS) and Action Score (AS);
e. combining the Participation Signal with the User Match Prediction to create a User Recommendation Signal indicating a Recommended User;
f. creating a link to a Recommended User indicated in the User Recommendation Signal;
g. providing to User 1, the link to the Recommended User, and h. collecting feedback of preferences and behavior of User 1 that is then iteratively fed back into the Recommender System and used in the above calculations.

17. The method of claim 15, wherein an Engagement Calculator calculates an Engagement Score (ES) from a plurality of Engagement Attributes normalized to a range between 0 and 1 that are then weighted according to importance, the Engagement Attributes comprising at least one of:
a. a number of sessions,
b. an average session duration,
c. a number of continuous use days of a specified length,
d. a number of pieces of art shared, and
e. a number of user profiles shared.

18. The method of claim 15, wherein a Cooperation Calculator calculates a Cooperation Score (CS) from a plurality of Cooperation Attributes normalized to a range between 0 and 1 that are then weighted according to importance, the Cooperation Attributes comprising at least one of:
a. a number of connection requests,
b. a number of connections accepted,
c. an average number of messages sent, and
d. an average message response time.

19. The method of claim 15, wherein an Action Calculator calculates an Action Score (AS) from a plurality of Action Attributes normalized to a range between 0 and 1 that are then weighted according to importance, the Action Attributes comprising at least one of:
a. a number of times a profile of User 1 is reported by another user;
b. a number of times artwork of Current User 1 is reported by another user;
c. a number of times a message of User 1 is reported by another user;
d. a number of times User 1 was blocked by another user; and
e. a number of times User 1 was removed from user matches by another user.

20. A method of producing an Art Recommendation by incorporating a measure of user participation into a Participatory Recommender System, comprising the steps of:
a. determining an Engagement Score (ES) from previously measured Engagement Attributes;
b. determining a Cooperation Score (CS) from previously measured Cooperation Attributes;
c. determining an Action Score (AS) from previously measured Action Attributes;
d. combining the Engagement Score (ES), Cooperation Score (CS) and the Action Score (AS) into a Participation Signal;
e. creating a Content-based Art Recommendation Component;
f. creating a Collaborative Filtering Art Recommendation Component;
g. combining the Content-based Art Recommendation Component and the Collaborative Filtering Art Recommendation Component to result in an Art Match Predictor for the Current User;
h. combining the Art Match Predictor with the Participation Signal into an Art Recommendation;
i. displaying to the Current User, Art pertaining to the Art Recommendation;
j. monitoring the Current User's actions regarding the Art displayed to update at least one of the Engagement Score (ES), Cooperation Score (CS) and the Action Score (AS) stored in the Behavior Storage.

21. The method of claim 20 further comprising the steps of:
a. creating a Content-based User Recommendation Component;
b. creating a Collaborative Filtering User Recommendation Component;
c. combining the Content-based User Recommendation Component and the Collaborative Filtering User Recommendation Component to result in a User Match Prediction for the Current User;
d. combining the User Match Prediction with the Participation Signal to create a User Match Recommendation recommending the Recommended User to the Current User;
e. providing to the Current User with a link to the Recommended User;
f. monitoring the Current User's actions regarding the link provided to update the Engagement Score (ES), Cooperation Score (CS), and the Action Score (AS) in the Behavior Storage.

22. The method of claim 21 further comprising the steps of, for each of a plurality of users:
a. plotting each user's Engagement Score (ES) on a multiple axis chart with a first axis being engagement, a second axis being cooperation and the third axis being action;
b. plotting each user's Cooperation Score (CS) on the cooperation axis of the chart;
c. plotting each user's Action Score (AS) on the action axis of the chart;
d. displaying the chart to the users;
e. combining the Engagement Score (ES), Cooperation Score (CS), and Action Score (AS) for each user into a Participation Score;
f. displaying the Participation Score normalized to a scale of 0-100 for each user;
g. averaging the Engagement Scores (ES) of all users into a Community Engagement Score;
h. averaging the Cooperation Scores (CS) of all users into a Community Cooperation Score;
i. averaging the Action Scores (AS) of all users into a Community Action Score;
j. comparing the Engagement, Cooperation, and Actions Scores of each user against the Community Engagement, Community Cooperation and Community Action Scores to create Percentile Rankings for each user relative to all users; and
k. displaying the Percentile Rankings to all users to foster each user to compete to improve their participation score, or influence, within the recommender system.
